(19) United States
(12) Patent Application Publication
(10) Pub. No.: US 2026/0018909 A1
(43) Pub. Date: Jan. 15, 2026

(54) Individual Cell Balancing

(71) Applicant: Eric Paul Grasshoff, San Marcos, CA (US)

(72) Inventor: Eric Paul Grasshoff, San Marcos, CA (US)

(21) Appl. No.: 18/822,221

(22) Filed: Sep. 1, 2024

Related U.S. Application Data
(63) Continuation-in-part of application No. 18/767,504, filed on Jul. 9, 2024.

(51) Int. Cl. H02J 7/00

(52) U.S. Cl. CPC H02J 7/0019; H02J 7/0048; H02J 7/007182

(57) ABSTRACT

An apparatus and method of balancing cells in a battery using an isolated power supply and pairs of switches to direct power to cells at a lower state of charge to bring them into balance with cells at a higher state of charge.

### CROSS-REFERENCE TO RELATED APPLICATIONS

This Continuation in Part patent application claims the benefit of U.S. Utility patent application Ser. No. 18/767,504 “INDIVIDUAL CELL BALANCING,” filed on Jul. 9, 2024, of which is incorporated by reference herein in its entirety.

### BACKGROUND—BRIEF DESCRIPTION

Batteries tend to get out of balance, meaning the cells that comprise the battery tend to drift into conditions in which their states of charge (SOCs) are mismatched. When batteries get out of balance, they lose capacity and reach end of life prematurely.

Many technologies have been developed to try to keep batteries balanced, or to restore balanced conditions to batteries that have become unbalanced. The most common approach to balancing batteries is passive balancing.

In passive balancing systems, energy is drained from cells at higher SOC to bring them down to the level of cells at lower SOC. To perfectly balance a battery using passive balancing, the SOCs of all of the cells in the battery must be drained down to the SOC of the lowest cell in the battery. The drained energy is diverted to load resistors where it is converted to heat. This is very inefficient as it is a waste of the electrical energy stored in the battery.

A new balancing technology is disclosed that is far more efficient and does not waste the electrical energy stored in the battery.

### BRIEF DESCRIPTION OF DRAWINGS

FIG. 1 illustrates a non-limiting example of the balancing technology disclosed herein as it is configured in accordance with one or more embodiments of the invention.

FIGS. 2 and 2a illustrate examples of logic for balancing cells in a battery using the system described in FIG. 1.

FIG. 3 illustrates a non-limiting example of the balancing technology with the addition of an Intermediate Control.

### DETAILED DESCRIPTION OF THE INVENTION

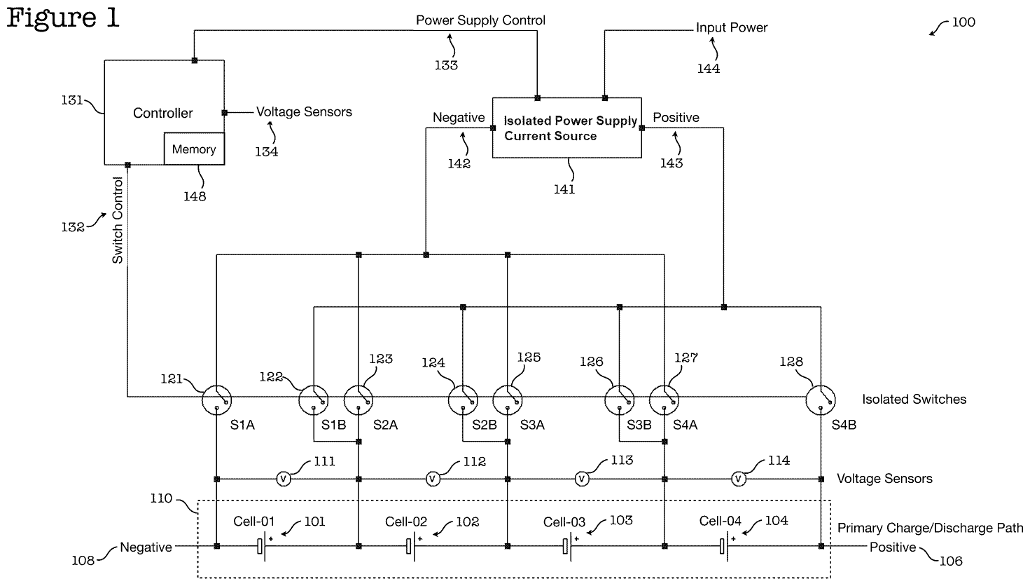

FIG. 1 illustrates a non-limiting example of the balancing technology disclosed herein as it is configured in accordance with one or more embodiments of the invention. System 100 is a system for balancing a battery 110 comprising at least four cells (101, 102, 103, 104) connected in series.

Voltage sensors (111, 112, 113, 114) are connected in parallel to each cell (101, 102, 103, 104). A pair of switches is connected to each cell (101, 102, 103, 104); one switch (121, 123, 125, 127) is connected to the negative terminal of each cell (101, 102, 103, 104) and one switch (122, 124, 126, 128) is connected to the positive terminal of each cell (101, 102, 103, 104).

A controller 131 controls the opened/closed status of each switch (121 . . . 128) via one or more switch control lines 132. And the controller 131 can turn a power supply 141 on and off via a power supply control line 133. The controller 131 also receives data from the voltage sensors (111, 112, 113, 114) via one or more voltage sensors data lines 134. Voltage data (and other data that may be used in the operation of the system 100) is stored in memory 148, which may be internal or external to the controller 131.

The power supply 141 can provide a current source to the cells (101, 102, 103, 104). The power supply 141 receives input power 144 from a power source (not shown in FIG. 1). When the power supply 141 is active and one pair of switches is closed, current flows from the positive terminal 143 of the power supply 141 to one of cells (101, 102, 103 or 104), and completes the current source circuit at the negative terminal 142 of the power supply 141.

The SOCs of cells (101, 102, 103, 104) can be increased by directing energy from the power supply 141 to a cell that is connected to the power supply 141 by closing selected switches. Specifically, energy can be directed to individual cells (101, 102, 103 or 104) by selectively closing switches 121 . . . 128, and by turning on the power supply 141 via a signal from the controller 131 that is transmitted via the power supply control line 133. When the power supply 141 is directing current to a cell, that cell is being charged.

### Determination of State of Balance of a Battery

If the states of charge (SOCs) of cells in a battery are at different levels, the battery is out of balance. If the SOCs of the cells in the battery are at the same (or nearly the same) level, the battery is balanced. As a non-limiting example, a battery may be considered to be balanced if the SOCs of the cells in the battery are within ±2% of each other.

### Estimation of State of Charge of Cells in a Battery

In order to estimate the state of balance of a battery, it is necessary to have an estimate or measurement of the SOC of each cell in the battery. If a battery architecture contains parallel chains of cells connected in series, then each parallel chain of cells may be considered to be equivalent to one large cell, because parallel chains of cells tend to self-balance.

Empirical measurement of the state of charge of cells in a battery is typically not feasible for batteries in their use environment (for example, in electric vehicles (EVs) or in battery energy storage systems (BESSes)). Therefore, it is common to estimate the SOC of each cell in a battery.

There are many means of estimating SOCs of cells in a battery. One means of estimating SOC of a cell is to measure cell voltage and apply a function that correlates cell voltage to SOC. A simple way of doing this is to use linear interpolation of cell voltage between the cell's low-voltage cut-off (which corresponds to 0% SOC) and the cell's high-voltage cut-off (which corresponds to 100% SOC). Another way of estimating SOC based solely on measurement of cell voltage is to use a charge/discharge curve for the cell. A charge/discharge curve shows SOC as a function of cell voltage, and is typically a non-linear curve. Measurements of cell voltage may be mapped onto points on the charge/discharge curve to provide an estimate of SOC.

Other, more sophisticated means of estimating SOC of cells incorporate other parameters in addition to cell voltage. Additional parameters that may be used to estimate SOC may include cell temperature; prior history of charge/discharge cycles that the cell has experienced; and/or counting coulombs on the battery's primary charge/discharge path while the battery is being charged or discharged. These are non-limiting examples of additional parameters that may be used to estimate SOC of cells in a battery.

Various mathematical models, functions or algorithms may be developed that use these parameters as inputs to estimate SOC. Estimation of SOC of cells in a battery is known art to those who have experience in battery management. This description of various means of estimating SOCs of cells in a battery is given to provide context for the description of the invention that follows.

### Default or General Conditions of the Balancing System

In the system 100, the default state of the switches 121 . . . 128 may be open.

In order for system 100 to function, power must be available from the input power source 144. In the following description, it is assumed that the input power source 144 is active, meaning it can provide a power source to the power supply 141.

The power supply 141 must be current-limited to prevent runaway current conditions that could damage the system 100. Design and use of current-limited power supplies is well known in the art.

The power supply 141 must be electrically isolated from the cells, because cells connected in series will be at differing voltages. Use of a transformer (not shown) between the power supply 141 and the cells (101, 102, 103, 104) is one means of isolating the power supply. Use of a transformer between the power supply 141 and the input power source 144 is another means of isolating the power supply. Isolation of power transfer between voltages of different levels is well known in the art.

The maximum voltage of the power supply 141 must be greater than the highest voltage that any of the individual cells (101, 102, 103, 104) will attain during normal operation of the system 100. As a non-limiting example, the maximum voltage of the power supply 141 may be greater than the full charge voltage (FCV) of the cells (101, 102, 103, 104). Typically, the battery manufacturer will specify FCV.

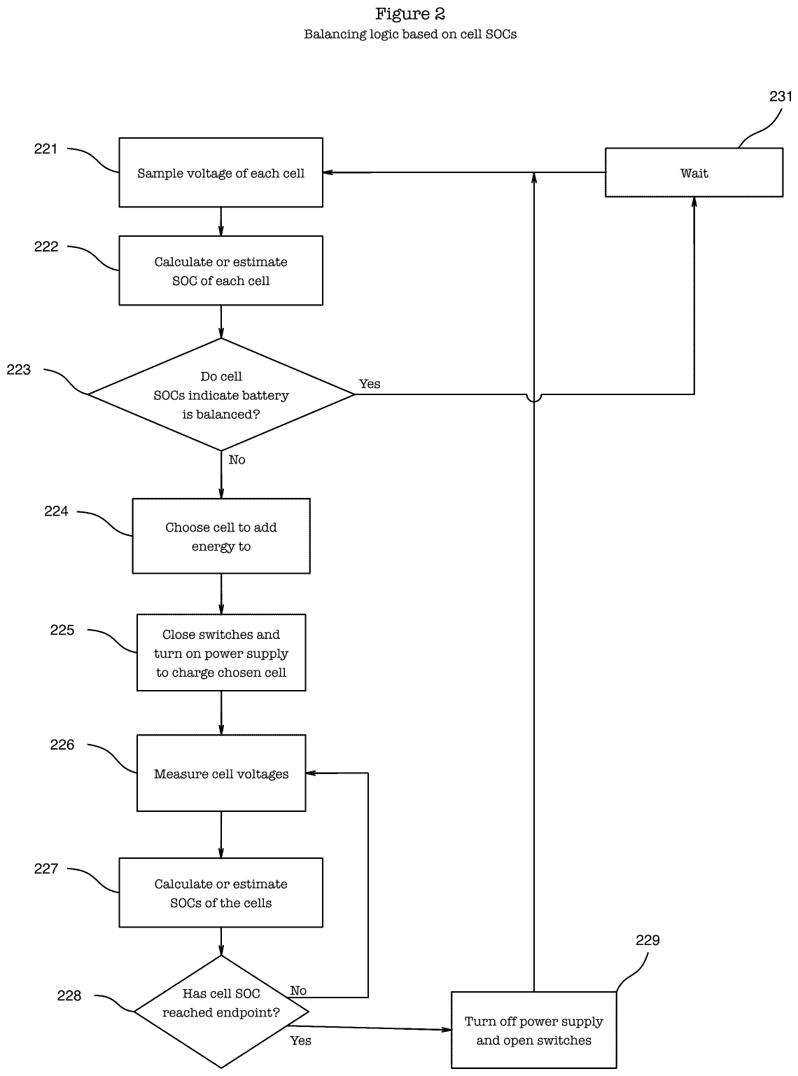

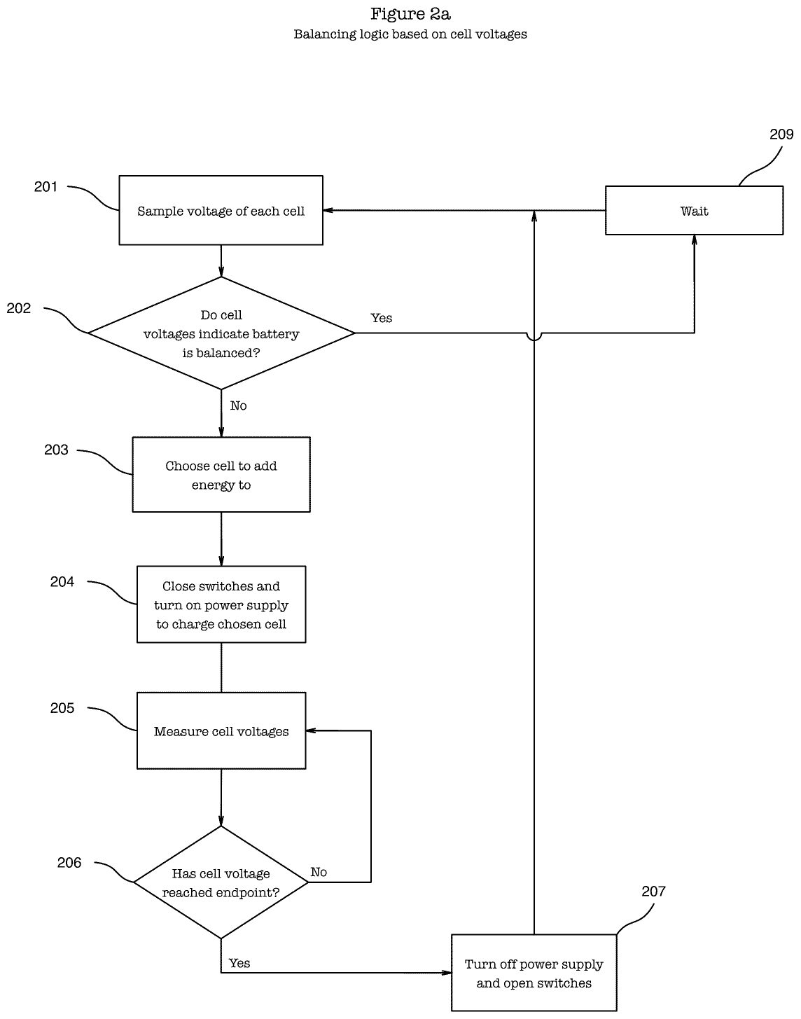

Referring now to FIG. 2: At step 221 the controller 131 samples data from the voltage sensors 111 . . . 114 via the voltage sensor data line 134. Cell voltage data may be stored in memory 148, which may be integrated in the controller 131 or may be a memory unit separate from the controller 131. Voltage sampling may occur on a regular (or irregular) interval. When the system 100 is monitoring the voltage and/or SOCs of the cells (101, 102, 103, 104) to determine if the battery is out-of-balance—i.e., when the system 100 is not balancing the battery—voltage sampling may occur between once per minute and once per hour, as a non-limiting example.

At step 222, cell voltage data is used to calculate and/or estimate the SOC of each cell (101, 102, 103, 104).

At step 223, it is determined if the battery is balanced or is out-of-balance by looking at the range of SOCs as calculated or estimated at step 222. As a non-limiting example, if the range of SOCs is greater than 2% of the nominal capacity of the cells, the battery may be considered to be out-of-balance.

If the battery is balanced, go to step 231: Wait for a voltage sampling interval (as described above), then return to step 221 and sample cell voltages again.

If the battery is not balanced (at step 223) go to step 224.

At step 224, the controller 131 chooses which cell to add energy to. To balance the battery, energy may be added to any cell that is at lower SOC than at least one other cell in the battery. Typically, energy will be added to the cell with lowest SOC in the battery, but that is not a strict requirement. After a cell is chosen to receive energy (i.e., to be charged) go to step 225.

At step 225, switches are closed to connect the chosen cell to the power supply 141 and then the power supply 141 is turned on.

For example, if the SOC of cell Cell-01 101, is lower than the SOCs of the other cells 102, 103, 104, then Cell-01 101 may receive energy (i.e., may be charged) to bring Cell-01 101 into balance with cells at higher SOC.

To add energy to Cell-01 101, the controller 131 closes switch S1A 121 which is connected to the negative terminal of Cell-01 101 and closes switch S1B 122 which is connected to the positive terminal of Cell-01 101. The controller 131 closes switch S1A 121 and switch S1B 122 using the switch control line 132. The controller 131 turns on the power supply 141 using the power supply control line 133.

When switches S1A 121 and S1B 122 are closed and power supply 141 is turned on, energy is added to Cell-01 101 (i.e., Cell-01 101 is being charged).

While energy is being added to Cell-01 101, the controller 131 can measure the voltages of all of the cells (101, 102, 103, 104) as shown at step 226, and can calculate or estimate the SOCs of the cells as shown at step 227.

At step 228, it is determined if the SOC of Cell-01 101 has reached an endpoint that indicates charging may stop on Cell-01 101. The charging endpoint may occur when the SOC of Cell-01 101 is equal (or approximately equal) to the SOC of the highest cell in the battery 110.

If it is determined at step 228 the charging endpoint has not been reached, return to step 226 and measure cell voltages again. When the system 100 is balancing a battery (i.e., cycling through steps 226, 227 and 228) cell voltage sampling may occur at a more frequent interval than when the controller is monitoring the state of the battery. During balancing, voltage sampling may occur between once per second and once per minute, as a non-limiting example.

If it is determined at step 228 that the charging endpoint has been reached, go to step 229.

At step 229, the controller does the following: Turns off the power supply 141 using the power supply control line 133, and uses the switch control line 132 to open the switches that had been closed, thereby disconnecting the cell from the power supply 141. When step 229 is completed, go back to step 221, in which the controller reverts to monitoring the conditions of the cells (101, 102, 103, 104) to determine if the battery is or is not balanced.

FIG. 2a illustrates an alternate means of balancing the cells in a battery using system 100. The flow of logic in FIG. 2a is similar to FIG. 2 with the following difference: The logic in FIG. 2a balances the cells in a battery by equalizing cell voltages. I.e., SOC of each cell is not calculated or estimated; rather, cell voltage is used as a proxy for SOC. A balancing system 100 that uses the logic shown in FIG. 2a may be simpler or easier to implement than a logic flow that includes a model or algorithm to estimate SOC. But a system that balances a battery by equalizing cell voltages may not balance the level of energy in the cells as accurately as a system that estimates or calculates SOC.

The above description is intended to illustrate the operation of the system 100 and is non-limiting. For example:

The size of the battery is not limited to four cells connected in series. The system 100 may be applied to batteries with any number of cells in series.

Each of the cells connected in series can be a single cell, or can be made up of multiple cells connected in parallel. In the latter case, groups of cells connected in parallel are treated as one large cell.

The controller can be any combination of hardware and software that is capable of performing the functions of the system 100 as described above.

The source of the input power 144 can be an external power supply which is used to charge the battery. Or the source of the input power 144 can be another battery, for example a separate 12V battery such as is commonly used in electric vehicles to provide power to the vehicle's electronic systems. The source of the input power is not limited to these two examples. The key point is that there is a source of input power 144 that can provide power to the power supply 141.

The switches can be any kind of switch capable of conducting currents that are desired for balancing the battery, for example FETs, such as MOSFETS.

When using the algorithm of FIG. 2, the state of balance (or out-of-balance) of the battery 110 is determined by estimating the SOC of each cell (101, 102, 103, 104). Estimation of SOC of cells in a battery is well known in the art; there are many means of estimating SOC and any of these means can be used in the balancing system 100. The key point is that the system 100 balances the battery 110 by adding energy to (i.e., charging) individual cells that are at a lower SOC than at least one other cell in the battery 110.

The wiring configuration shown in FIG. 1 for the switches 121 . . . 128 is one example of how switches may be connected to the power supply 141 and the cells (101, 102, 103, 104). Other wiring configurations may be employed. The key concept is that a set of switches is configured in a manner that allows individual cells (101, 102, 103, 104) to be connected to the power supply 141 to enable charging of individual cells (101, 102, 103, 104).

There can be one or more than one voltage sensor data line 134.

There can be one or more than one switch control line 132.

There can be various criteria for determining when to stop charging a cell (101, 102, 103, 104). One criterion is to stop charging when the SOC (or voltage) of the cell being charged is equal, or approximately equal, to the SOC (or voltage) of the cell with the highest SOC. Another possible criterion is to stop charging when the voltage of the cell being charged is equal, or nearly equal, to the full charge voltage of the cells (typically as specified by the cell manufacturer). Another possible criterion is to stop charging when the SOC of the cell being charged is equal, or nearly equal, to the average SOC of the cells that currently are not being charged. These are examples; other criteria are possible. The key concept is that the battery is balanced by adding energy to (i.e., charging) cells with lower SOC, as opposed to draining energy out of (i.e., discharging) cells with higher SOC.

If it is desired to have a system 100 that can charge more than one cell at a time, a plurality of mutually isolated power supplies may be used. For example: To be able to charge two cells simultaneously, two isolated current-limited power supplies may be used.

### Intermediate Control

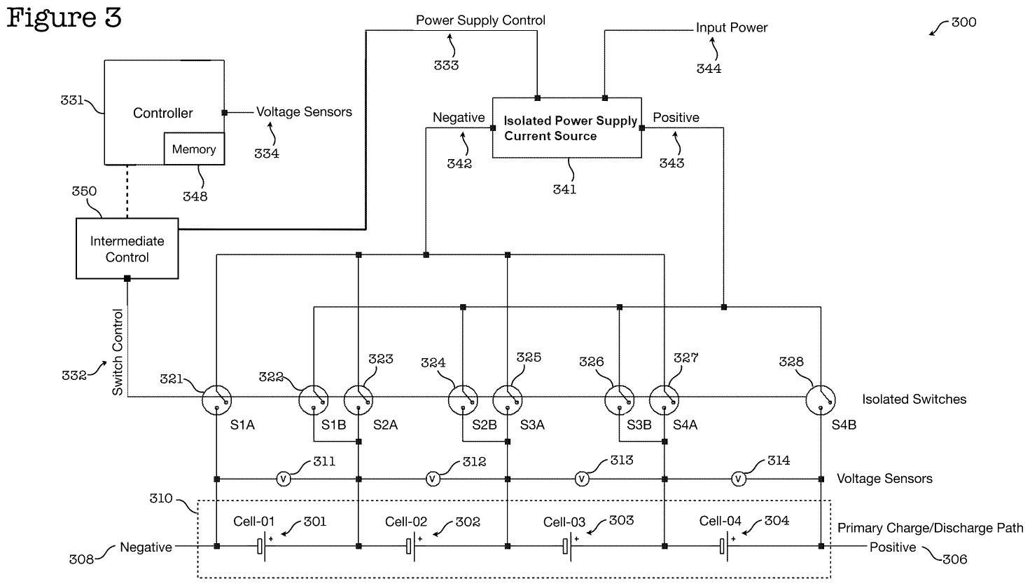

In some embodiments, the Controller 131 might not directly control the switches (121 . . . 128). In these embodiments, there might be an Intermediate Control means as shown in FIG. 3. FIG. 3 is nearly identical to FIG. 1; the sole difference being the addition of Intermediate Control 350. Intermediate control of the switches (321 . . . 328) may be preferred in some battery systems. For example, in large batteries, the switches may be relays that have higher current capacity than MOSFETs, in which case it may be preferred to have switch control 332 separate and/or isolated from the Controller 331.

In FIG. 3, the line connecting the Controller 331 to the Intermediate Control 350 is shown as a dashed line, indicating that the connection between these two elements is not necessarily a direct or hard-wired connection. If the connection is direct or hard-wired, the Controller 331 may directly send data about the voltages and/or SOCs of the cells (101 . . . 104) to the Intermediate Control 350, providing the information needed for the Intermediate Control 350 to determine when switches should be open and which switches to close. The Intermediate Control 350 may then close switches and turn on the power supply 341.

In some embodiments, an indirect connection between the Controller 331 to the Intermediate Control 350 may involve a human. For example, the Controller 331 may present information on the voltages and/or SOCs of the cells (101 . . . 104) to a person via video display, audio signal, or any other means by which an electronic system may convey information to a human. The human may use that information to determine which switches (if any) should be closed. The human may then take action to close a pair of switches and to turn on the power supply 341 to start charging a selected cell.

While a cell is being charged, the Controller 331 may provide data on the voltage and/or SOC of the cell being charged relative to the voltages and/or SOCs of the other cells in the battery. This information can be used to determine when to stop charging.

In some embodiments of system 300, the Controller 331 may provide data on cell voltages to the Intermediate Control 350, and the Intermediate Control 350 may use cell voltage data to determine whether and which switches should be closed. This determination may be made by an automated system or by a human.

In other embodiments of system 300, the Controller 331 may provide estimates of the SOCs of the cells, and the Intermediate Control 350 may use the estimates of SOCs to determine whether and which switches should be closed. This determination may be made by an automated system or by a human.

In other embodiments, the Controller 331 may provide information on which switches should be closed and the Intermediate Control 350 causes those switches to be closed.

More generally, in system 300 the Controller 331 receives data on cell voltages and the Intermediate Control 350 controls opening and closing of the switches and controls turning the power supply on and off. Processing cell voltage data to determine which switches should be closed, and when to turn the power supply on and off may be performed by the Controller 331, or the Intermediate Control 350, or may be divided between these two elements. The functions of the Intermediate Control 350 may be performed solely by an automated system, or human action may enable some or all of the functions of Intermediate Control 350.

Those with skill in the art will appreciate that there may be other variations of means to determine which cells need to be charged and then connecting those cells to a power supply to charge them in order to balance a battery. Again, the key concept is that this system balances a battery by directing energy to (i.e., charging) individual cells that are at lower voltage and/or SOC than other cells in the battery, as opposed to passive balancing technology that balances a battery by draining energy out cells with higher voltage and/or SOC to bring them down to the level of cells at lower voltage and/or SOC.

### Discussion

A common condition that causes batteries to get into out-of-balance conditions is when one or a few cells in a battery become leaky, meaning their self-discharge rate is higher (usually significantly higher) than the self-discharge rate of the other cells in the battery.

This is a worst-case condition for passive balancing systems, because the leaky cell or cells are constantly discharging and their SOCs are constantly declining relative to the other cells in the battery which have normal self-discharge rates. In this situation, passive balancing systems must continuously (or nearly continuously) drain energy from all of the cells in the battery that have normal self-discharge rates. This wastes energy and generates heat, both of which are undesirable. This situation can quickly degrade to a point where passive balancing systems are not effective and the battery reaches end of life prematurely and must be replaced or scrapped-all because of one or a few leaky cells in an otherwise good battery.

If a battery is in the condition described above, the system 100 can be very effective at keeping the battery in balance. The system 100 simply needs to add energy to the one or a few cells that have high self-discharge rate to bring their SOCs up to par with the remainder of the cells in the battery. When the leaky cell(s) start to drift down again, the system 100 can quickly charge them back up to par again.

Thus, the system 100 provides an effective and low-cost way to correct out-of-balance conditions in batteries that have one or a few leaky cells, which is one of the most common causes of out-of-balance batteries.

1. An apparatus comprising:
A battery comprised of a plurality of cells connected in series;
a power supply having a positive terminal and a negative terminal, where the power supply is connected to an input power source;
a plurality of switches configured to allow any individual cell in the battery to be connected to the power supply by selectively closing a pair of switches from the plurality of switches;
a plurality of voltage sensors, wherein each voltage sensor is connected in parallel to one of the cells in the battery; and
a controller that controls a power supply control line and a switch control line, the controller being configured to receive and store data from the voltage sensors;
wherein the controller can selectively close pairs of switches amongst the plurality of switches to connect any cell in the battery to the power supply and can turn on the power supply to add energy to individual cells in the battery.

2. The apparatus of claim 1 wherein the power supply is a current-limited power supply.

3. The apparatus of claim 1 wherein the power supply is isolated.

4. The apparatus of claim 1 wherein the plurality of switches is configured as follows:
each switch is connected to a positive terminal or a negative terminal of a cell in the battery, and each switch that is connected to a positive terminal of a cell is connected to the positive terminal of the power supply and each switch that is connected to a negative terminal of a cell is connected to the negative terminal of the power supply.

5. A method of balancing series-connected cells in a battery comprises:
measuring voltages of the cells and choosing a cell whose state of charge (SOC) or voltage is lower than at least one other cell in the battery (the “chosen cell”);
closing switches to connect the chosen cell to a power supply;
turning on the power supply to direct electrical energy to the chosen cell to raise its SOC or voltage;
and turning off the power supply when the SOC or voltage of the chosen cell reaches a desired state.

6. The method of claim 5 in which the steps in claim 5 are repeated until the battery is balanced.

7. The method of claim 5 in which cell voltage is the only parameter that is used to estimate the SOCs of the cells.

8. The method of claim 5 in which the SOC of each cell is estimated using an algorithm, formula or model that uses cell voltage and other data.

9. The method of claim 5 in which the state of balance of the battery is determined solely by evaluating variations in cell voltages, without estimating the SOCs of the cells.

10. An apparatus comprising:
A battery comprised of a plurality of cells connected in series;
a power supply having a positive terminal and a negative terminal, where the power supply is connected to an input power source;
a plurality of switches configured to allow any individual cell in the battery to be connected to the power supply by selectively closing a pair of switches from the plurality of switches;
a plurality of voltage sensors, wherein each voltage sensor is connected in parallel to one of the cells in the battery;
a controller that receives cell voltage data from the voltage sensors;
an intermediate control that controls an on/off state of the power supply and controls an open/closed states of the plurality of switches; and
the apparatus being configured to receive voltage data from the plurality of voltage sensors and use the voltage data to select which of the plurality of switches to close, and then close at least one selected switch to connect any cell in the battery to the power supply, and turn on the power supply to add energy to at least one of the cells in the battery.

11. The apparatus of claim 1 wherein the power supply is a current-limited power supply.

12. The apparatus of claim 1 wherein the power supply is isolated.

13. The apparatus of claim 1 wherein the plurality of switches is configured as follows:
each switch is connected to a positive terminal or a negative terminal of a cell in the battery, and each switch that is connected to a positive terminal of a cell is connected to the positive terminal of the power supply and each switch that is connected to a negative terminal of a cell is connected to the negative terminal of the power supply.
